(19) United States
(12) Patent Application Publication
(10) Pub. No.: US 2022/0343327 A1
(43) Pub. Date: Oct. 27, 2022

(54) VERIFICATION AND TRANSACTION SYSTEM FOR LIMITED-QUANTITY RELEASED DIGITAL WORKS

(71) Applicant: ELFACTORY CO., LTD., Seoul (KR)

(72) Inventor: Kyungtae LEE, Goyang-si (KR)

(21) Appl. No.: 17/716,137

(22) Filed: Apr. 8, 2022

(30) Foreign Application Priority Data
Apr. 22, 2021 (KR) 10-2021-0052066

(51) Int. Cl. G06Q 20/40; G06Q 20/38; G06Q 20/06

(52) U.S. Cl. CPC G06Q 20/4014; G06Q 20/3825; G06Q 20/389; G06Q 20/065

(57) ABSTRACT

According to an exemplary embodiment of the present invention, it is possible to derive activation of the image contents by providing a verification and transaction method for an authority which may be transferred through an individual transaction of limited-quantity specific image contents apart from a use authority of an image content providing system constituted by a digital photo frame and a user terminal controlling the digital photo frame, and a service providing server providing an image content service to a digital photo frame based on the control.

### CROSS-REFERENCE TO RELATED APPLICATION(S)

This application claims priority from Korean Application No. 10-2021-0052066 filed on Apr. 22, 2021, which application is incorporated herein by reference in its entirety.

### BACKGROUND

### 1. Field of the Invention

The present invention relates to a verification and transaction system for limited-quantity released digital works.

### 2. Description of the Related Art

A digital photo frame means a device that displays, to a display device such as an LCD, etc., image contents photographed by a camera, etc., or image contents acquired by digitalizing a work of a pointer, etc. It is general that the digital photo frame in related art can display the image contents to the display device by controlling a terminal.

In recent years, technologies have emerged, which separately store the image contents in a network storage of a cloud server and transmit, to the display device, the image contents stored in the network storage by using the terminal. The related art is a situation in which with commercial needs of content providers and development of the cloud server, qualitative expansion and quantitative expansion such as development of various applications, etc., are made.

However, as digital works, the image contents are copyrighted objects, but copyright infringement, protection, and management issues emerge due to easy replication and reworking, and as a result, active content protection activities such as fundamentally blocking illegal replication and using various copyright protection technologies such as DRM, etc., are conducted.

A recent trend to block the illegal replication of the digital works on an extension line of the active content protection activities is to perform release, utilization, and distribution of the digital works only within a specific service providing platform. Types such as the digital photo frame and a terminal capable of controlling the digital photo frame, and a service providing server providing a streaming service of the image contents appear as elements for constructing an image content service providing platform.

Copyright protection for digital image contents may lead to the use of closed contents to inhibit activation of the contents, while when the technology is operated in an opened form like an open market, replication of the digital image contents becomes easy, and as a result, there is a disadvantage in that it is difficult to protect the copyright.

Accordingly, introduction of the service providing platform and the transaction system capable of increasing values of the digital image contents emerges while the activation of the digital image contents and the copyright protection are simultaneously satisfied.

### SUMMARY

The present invention is contrived based on the need, and a first object of the present invention is to provide a verification and transaction system for limited-quantity released digital works, which is capable of activating use and distribution of contents in addition to copyright protection of image contents which are digital works.

A second object of the present invention is to provide a verification and transaction system for digital works, which is capable of protecting values of digital works and enabling safe distribution through individual transactions for limited-quantity released digital works.

A third object of the present invention is to provide a verification and transaction system for digital works, which is capable of providing an open market platform and verifying limited-quantity digital works so as to enable individual transactions for limited-quantity released digital works.

A fourth object of the present invention is to provide a verification and transaction system for digital works, which is capable of deriving activation of image contents by providing a verification and transaction method for an authority which may be transferred through an individual transaction of limited-quantity specific image contents apart from a use authority of an image content providing system constituted by a digital photo frame and a user terminal controlling the digital photo frame, and a service providing server providing an image content service to a digital photo frame based on the control.

An exemplary embodiment of the present invention provides a verification and transaction system for limited-quantity released digital works, which may include: a service providing server storing, managing, processing, editing, encoding, and transmitting image contents corresponding to the digital works, and performing registration of a first user having a use authority of the image contents; a display device being transmitted with the encoded image contents and displaying the transmitted image contents; an electronic commerce unit performing charging and payment for the purchase of the image contents of the registered first user; and a first user terminal controlled by a manipulation by the first user to transmit the purchased image contents from the service providing server to the display device, in which the electronic commerce unit may further provide an open market platform for a first individual transaction of the purchased image contents between the first user and a registered second user.

In an exemplary embodiment, the electronic commerce unit may include a user payment unit performing account registration and payment for the first transaction of the image contents to the second user, an authority change registration unit registering a use authority change for the image contents transferred to the second user as a result of the first transaction, and transmitting the registered use authority change information to the service providing server, and a transaction book writing unit writing first individual transaction information corresponding to the first transaction and transmitting the written first individual transaction information to user terminals of the first to N-th respective users having the authority for the image contents.

In an exemplary embodiment, the service providing server may include a user authority registration unit dividing an electronic signature received from the copyright holder of the digital work into a number corresponding to a limited released quantity and allocating the divided electronic signatures to the first to N-th users purchasing the image contents, and transmitting the allocated divided electronic signatures to the user terminals of the first to N-th respective users, and a use authorization unit authorizing the use of the image contents by verifying the allocated divided electronic signatures in response to a service use request.

In an exemplary embodiment, the transaction book writing unit may write second individual transaction information in response to a second transaction generated after the first transaction, but write an electronic transaction book in which both the first individual transaction information and the second individual transaction information are written, and transmit the electronic transaction book to the user terminals of the first to N-th respective users having the authority for the image contents.

In an exemplary embodiment, the service providing server may include a user authority registration unit dividing an electronic signature received from the copyright holder of the digital work into a number corresponding to a limited released quantity and allocating the divided electronic signatures to the first to N-th users purchasing the image contents, and transmitting the allocated divided electronic signatures to the user terminals of the first to N-th respective users, and a use authorization unit authorizing the use of the image contents by verifying the allocated divided electronic signatures in response to a service use request, but the use authorization unit may authorize the use of the image contents by verifying the allocated divided electronic signatures and the transmitted electronic transaction book.

Another exemplary embodiment of the present invention provides a verification and transaction method for limited-quantity released digital works, which may include: storing and holding image contents corresponding to the digital works; receiving a registration request for a use authority of the image contents from a first user terminal; performing charging and payment for purchasing the image contents according to the received registration request; receiving a transmission request for the image contents from the first user terminal after the charging and the payment are completed; performing an authentication procedure for a first display terminal based on terminal information for the first display terminal included in the transmission request when receiving the transmission request; and transmitting the image contents to the first display terminal when an authentication for the first display terminal is completed.

In an exemplary embodiment, the verification and transaction method for limited-quantity released digital works may further include encoding the image contents by considering a terminal specification of the first display device terminal.

In an exemplary embodiment, the verification and transaction method for limited-quantity released digital works may further include: collecting a transaction request for the image contents from the first user terminal to a previously registered second user terminal; checking a use authority for the image contents of which the transaction request occurs; and approving an electronic commerce of the first user terminal as a checking result of the use authority.

In an exemplary embodiment, the verification and transaction method for limited-quantity released digital works may further include: when the electronic commerce of the first user terminal is approved, performing account registration and payment for a first transaction to the second user terminal through an open market platform; registering a use authority change for the image contents transferred to the second user terminal as a result of the first transaction; and transmitting the registered use authority change information to a service providing server.

In an exemplary embodiment, the verification and transaction method for limited-quantity released digital works may further include: writing first individual transaction information corresponding to the first transaction; and transmitting the written first individual transaction information to user terminals of first to N-th respective users having an authority for the image contents.

In an exemplary embodiment, the verification and transaction method for limited-quantity released digital works may further include: dividing an electronic signature received from a copyright holder of the digital work into a number corresponding to a limited released quantity and allocating the divided electronic signatures to the first to N-th users who purchase the image contents; and transmitting the allocated divided electronic signatures to the user terminals of the first to N-th respective users.

In an exemplary embodiment, the verification and transaction method for limited-quantity released digital works may further include: writing second individual transaction information in response to a second transaction generated after the first transaction, but writing an electronic transaction book in which both the first individual transaction information and the second individual transaction information are written; and transmitting the electronic transaction book to the user terminals of the first to N-th respective users having the authority for the image contents.

In an exemplary embodiment, the verification and transaction method for limited-quantity released digital works may further include: dividing the electronic signature received from the copyright holder of the digital work into a number corresponding to a limited released quantity and allocating the divided electronic signatures to the first to N-th users purchasing the image contents, and transmitting the allocated divided electronic signatures to the user terminals of the first to N-th respective users; and authorizing the use of the image contents by verifying the allocated divided electronic signatures in response to a service use request, in which the authorizing of the use may include authorizing the use of the image contents by verifying the allocated divided electronic signatures and the transmitted electronic transaction book.

According to an exemplary embodiment of the present invention, there is an effect that use and distribution of contents can be activated in addition to copyright protection of image contents which are digital works.

Further, values of the digital works are protected and safe distribution is enabled through individual transactions of limited-quantity released digital works.

In addition, it is possible to verify limited-quantity digital works which are distributed simultaneously with providing an open market platform so as to enable individual transactions of the limited-quantity released digital works.

Most of all, it is possible to derive activation of the image contents by providing a verification and transaction method for an authority which may be transferred through an individual transaction of limited-quantity specific image contents apart from a use authority of an image content providing system constituted by a digital photo frame and a user terminal controlling the digital photo frame, and a service providing server providing an image content service to a digital photo frame based on the control.

### BRIEF DESCRIPTION OF THE DRAWINGS

FIG. 1 is a configuration diagram illustrating a configuration of an exemplary embodiment of a verification and transaction system for limited-quantity released digital works, which is the present invention.

FIG. 2 is a configuration diagram in which configurations of an exemplary embodiment of a verification and transaction system for limited-quantity released digital works which is the present invention illustrate a signal flow according to individual transactions.

FIG. 3 is a flowchart illustrating an exemplary embodiment of a verification and transaction system for limited-quantity released digital works which is the present invention.

FIG. 4 is a flowchart illustrating an exemplary embodiment of changing a use authority.

FIG. 5 is a flowchart illustrating an exemplary embodiment in which a user terminal having an authority for image contents allocates and manages a divided electronic signature.

### DETAILED DESCRIPTION

Hereinafter, exemplary embodiments of the present invention will be described in detail with reference to the accompanying drawings and the contents disclosed in the accompanying drawings, but the present invention is not limited or restricted to the exemplary embodiments.

Various modifications may be made to exemplary embodiments to be described below. Exemplary embodiments to be described below are not intended to be limited to aspects and should be understood to include all modifications, equivalents, and substitutes thereof.

Terminologies used in the exemplary embodiments are used only to describe specific exemplary embodiments, and are not intended to limit the exemplary embodiments. A singular form includes a plural form if there is no clearly opposite meaning in the context. Further, in this specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Meanwhile, in describing the present invention, detailed description of associated known function or constitutions will be omitted if it is determined that they unnecessarily make the gist of the present invention unclear. Terminologies used herein are a terminologies used to properly express exemplary embodiments of the present invention, which may vary according to a user, an operator's intention, or customs in the art to which the present invention pertains. Accordingly, definitions of the terminologies need to be described based on contents throughout this specification.

If not contrarily defined, all terms used herein including technological or scientific terms have the same meanings as those generally understood by those skilled in the art. Terms which are defined in a generally used dictionary should be interpreted to have the same meaning as the meaning in the context of the related art, and are not interpreted as an ideal meaning or excessively formal meanings unless clearly defined in this specification.

In addition, in the description with reference to the accompanying drawings, like components regardless of reference numerals designate like reference numerals and a duplicated description thereof will be omitted. In describing the exemplary embodiments, a detailed description of related known technologies will be omitted if it is determined that they unnecessarily make the gist of the exemplary embodiments unclear.

### Verification and Transaction System for Limited-Quantity Released Digital Works

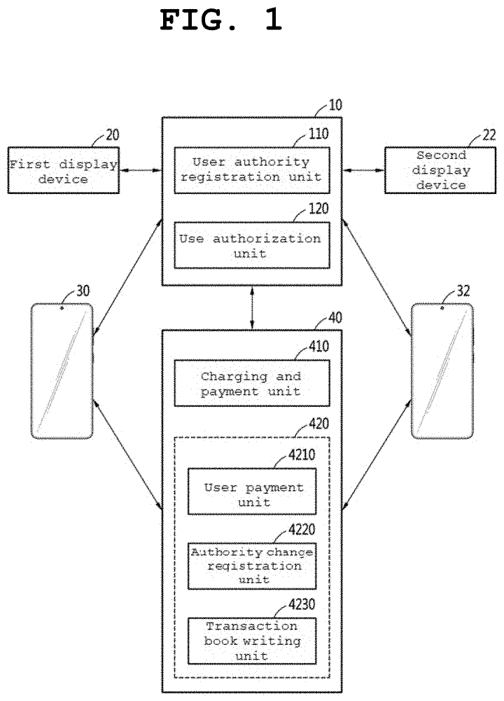

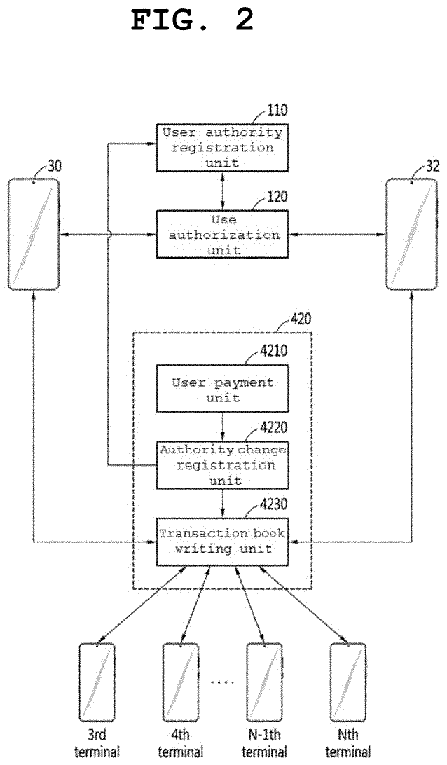

FIG. 1 is a configuration diagram illustrating a configuration of an exemplary embodiment of a verification and transaction system for limited-quantity released digital works, which is the present invention and FIG. 2 is a configuration diagram in which configurations of an exemplary embodiment of a verification and transaction system for limited-quantity released digital works which is the present invention illustrate a signal flow according to individual transactions.

The verification and transaction system for digital works according to the present invention may use and distribute contents in addition to copyright protection of image contents which are digital works.

Further, values of the digital works are protected and safe distribution is enabled through individual transactions of the limited-quantity released digital works, and it is possible to verify distributed limited-quantity digital works simultaneously with providing an open market platform so as to enable the individual transactions of the limited-quantity released digital works.

Most of all, it is possible to derive activation of the image contents by providing a verification and transaction method for an authority which may be transferred through an individual transaction of limited-quantity specific image contents apart from a use authority of an image content providing system constituted by a digital photo frame and a user terminal controlling the digital photo frame, and a service providing server providing an image content service to a digital photo frame based on the control.

To this end, as illustrated in FIG. 1, the verification and transaction system for limited-quantity released digital works may include a service providing server 10, a first display device 20, a second display device 22, a first user terminal 30 a second user terminal 32, and an electronic transaction unit 40.

First, the service providing server 10 may store, manage, process, edit, encode, and transmit the image contents corresponding to the digital works, and perform registration of a first user having a use authority of the image contents.

To this end, the service providing server 10 may include a use authority registration unit 110 and a use authorization unit 120.

The user authority registration unit 1110 according to an exemplary embodiment may divide an electronic signature received from a copyright holder of the digital work into a number corresponding to a released limited quantity.

For example, when the copyright holder releases 10 image contents for digital works possessed thereby, the electronic signature may be divided into 10 to meet the respective image contents.

Further, the user authority registration unit 110 may allocate divided electronic signatures to first to N-th users who purchase the image contents, and transmit the divided electronic signatures allocated to the user terminals of the first to N-th respective users.

The use authorization unit 120 may authorize the use of the image contents by verifying the allocated divided electronic signatures in response to a service use request.

For example, the use authorization unit 120 may authorize the use of the image contents by checking the electronic signatures held by the user terminals after division. In this case, one electronic signature may be checked and all of the electronic signatures for the first to N-th respective users may be checked. Further, electronic signatures for at least some user terminals of the first to N-th respective user terminals may also be checked.

Further, at least one of the first display device 20 or the second display device 22 may be transmitted with the encoded image contents and display the transmitted image contents.

That is, at least one of the first display device 20 or the second display device 22 may be construed as various devices including a communication module and a display module.

Next, the electronic commerce unit 40 may charge and perform payment for purchase of the image contents of the registered first user.

To this end, the electronic commerce unit 40 may include a charge payment unit 410 and an open market platform 420.

The charge payment unit 410 may process storing, managing, processing, editing, encoding, and transmission of the image contents or perform payment processing for a charge generated in the process of registering a user having the use authority of the image contents.

The electronic commerce unit 40 includes a payment server or interlocks with an external payment server to perform the payment processing.

Meanwhile, the open market platform which is used for the individual transactions may transmit the divided electronic signatures to the first to N-th users who purchase the image contents by writing a transaction book when the individual transactions are completed.

To this end, the open market platform 420 according to an exemplary embodiment may include a user payment unit 4210, an authority change registration unit 4220, and a transaction book writing unit 4230.

The user payment unit 4210 may perform account registration and payment at a first transaction for selling the mage contents from the first user to the second user. Similarly, the open market platform 420 includes the payment server or interlocks with the external payment server to process the account registration and the payment.

The authority change registration unit 4220 may register a use authority change for the image contents transferred to the second user as a first transaction result. Further, the authority change registration unit 4220 may transmit the registered use authority change information to the service providing server 10.

The transaction book writing unit 4230 may write first individual transaction information corresponding to the first transaction and transmit the written first individual transaction information to the user terminals of the first to N-th respective users having the authority for the image contents.

For example, when the copyright holder releases 10 image contents for the digital work possessed thereby, the transaction book writing unit 4230 may transmit the first individual transaction information corresponding to the first transaction only to the user terminal having the electronic signature divided into 10.

According to an exemplary embodiment, the transaction book writing unit 4230 may write second individual transaction information in response to a second transaction generated after the first transaction. That is, the transaction book writing unit 4230 may write an electronic transaction book in which both the first individual transaction information and the second individual transaction information are written, and transmit the electronic transaction book to the user terminals of the first to N-th respective users having the authority for the image contents.

Further, the first user terminal 30 may be controlled by a manipulation by the first user so as to transmit the purchased image contents from the service providing server 10 to the display device.

Meanwhile, the electronic commerce unit 40 may further provide the open market platform 420 for a first individual transaction of the purchased image contents between the first user and the registered second user.

The present invention provides a digital photo frame service system which may maximize the utilization of the image contents by transmitting image contents selected by a user to the display device through the cloud server.

FIG. 2 is a diagram for describing a transaction for a digital work between users.

The user authority registration unit 110 may divide an electronic signature received from the copyright holder of the digital work into a number corresponding to a limited released quantity and allocate the divided electronic signatures to the first to N-th users purchasing the image contents, and transmit the allocated divided electronic signatures to the user terminals of the first to N-th respective users.

Further, the use authorization unit 120 may authorize the use of the image contents by verifying the allocated divided electronic signatures in response to a service use request.

Thereafter, the transaction book writing unit 4230 may write the transaction book with a work price set upon initial release. Further, the transaction book may be accompanied by the traction of limited encrypted work data.

To this end, a digital photo frame server may include a work streaming transmission unit, a digital work payment unit, and a transaction book writing unit, and the payment is made through the work payment unit upon the initial release, and when the payment is made, the payment may be configured to be transmitted and displayed to the digital photo frame terminal through the work transmission unit as streaming data.

The payment of the cost is made through the work payment unit in return for transferring a right capable of being transmitted with the stream data by the digital photo frame terminal without a limit of a period to 100 users or work users for a limited quantity, e.g., 100 digital works.

The digital work is configured to be displayed only through the digital photo frame terminal, and as a result, only the second user is enabled to display limited-quantity digital works when the limited-quantity digital works are transferred from the first user to the second user. Meanwhile, the display of the digital work of the second user is enabled only through a digital photo frame terminal possessed or managed by the second user.

The transfer and an acquisition between the first and second users are made through an individual transaction server of the digital work, which interlocks with the electronic commerce unit 420. The payment of the cost may also be configured in the individual transaction server so as to be made through accounts registered by the first and second users in response to the transfer and the acquisition.

That is, the individual transaction server is constituted by a user information fetching component, a user account registration unit, a digital work information providing unit (what numberth released digital data among limited-quantity digital works is), and the transaction book writing unit. Therefore, when the transfer and the acquisition are made, the transaction book writing unit writes user information, digital work specific information, work price information, and transaction temporary information in the transaction book.

The transaction book is sent to all of the limited-quantity digital works. That is, an agreement before the transaction of the limited-quantity digital works used by third and fourth users and a transaction result after the traction are notified. Even though the users do not continuously check the transaction book, when the individual transaction of the digital work occurs, the digital book is configured to be updated upon the individual transaction.

When next transfer and acquisition between individuals occur, the digital book may be updated, and different users of the same digital work may approve and may be notified with the transaction book, and as a result, the user may know a release quantity, a transaction quantity, and a price of the digital work thereof in real time and know the value of the digital work of the user through fluctuation information of the price.

The transaction book is shared by all of the limited-quantity digital works and a transaction book updated according to a new transaction is continuously shared by all digital works.

In such a sharing scheme, the digital work is kept by setting a transaction book storage of the digital photo frame. A digital photo frame terminal that displays limited-quantity digital works of the same work continuously interlocks with the payment server to send and receive an encrypted transaction book. The reason is that since the individual transaction is made through the individual payment server, data is transmitted to the transaction book storage of the digital photo frame of each user via the individual payment server.

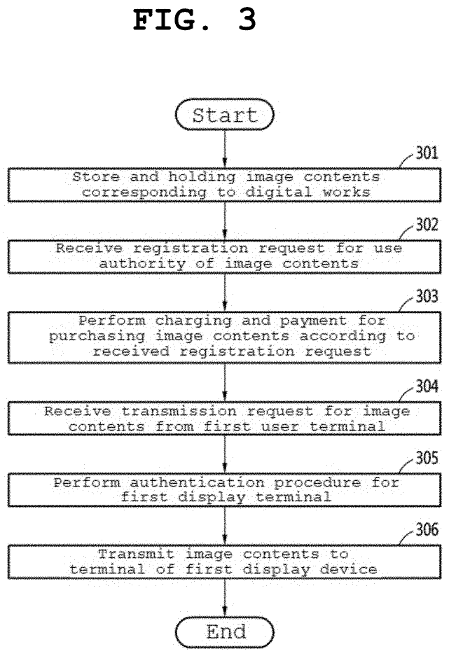

FIG. 3 is a flowchart illustrating an exemplary embodiment of a verification and transaction system for limited-quantity released digital works which is the present invention.

In the verification transaction method for digital works according to an exemplary embodiment, image contents corresponding to a digital work may be stored and held (step 301).

Next, in the verification transaction method for digital works, a registration request for a use authority of the image contents may received (step 302), and charging and payment for purchasing the image contents may be performed according to the received registration request (step 303). For example, the charging and payment for purchasing the image contents may be performed through the external payment server according to the received registration request.

In the verification transaction method for digital works, the charging and the payment are completed, and then a transmission request for the image contents may be received from the first user terminal (step 304), and an authentication procedure for a first display terminal may be performed (step 305).

For example, when the transmission request is received, the authentication procedure for the first display terminal may be performed based on terminal information on the first display terminal, which is included in the transmission request. As an example, the terminal information may include unique identification information for the terminal, a previously distributed authentication key, an electronic signature, etc.

Thereafter, in the verification transaction method for digital works, when an authentication for the first display terminal is completed, the image contents may be transmitted to the terminal of the first display device (step 306).

In transmitting the image contents, the image contents may be encoded by considering a terminal specification of the display device in the verification transaction method for digital works.

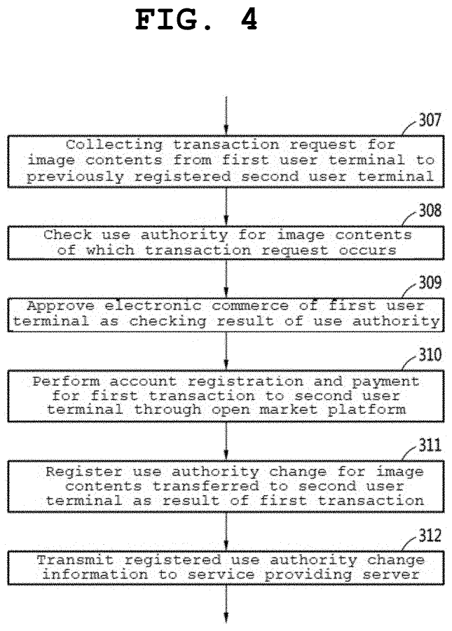

FIG. 4 is a flowchart illustrating an exemplary embodiment of changing a use authority.

FIG. 4 may be executed after step 306 of FIG. 3 or independently executed in a separate routine.

First, in the verification transaction method for digital works, in order to change the use authority, a transaction request for the image contents to the second user terminal which is previously registered may be collected from the first user terminal (step 307).

Next, the use authority for the image contents of which the transaction request occurs may be checked (step 308), and as a checking result of the user authority, the electronic commerce of the first user terminal may be approved (step 309).

Thereafter, when the electronic commerce of the first user terminal is approved, the account registration and the payment may be performed for the first transaction to the second user terminal through the open market platform (step 310), and as a result of the first transaction, the use authority change for the image contents transferred to the second user terminal may be registered (step 311).

Further, in the verification transaction method for digital works, the registered use authority change information may be transmitted to the service providing server (step 312).

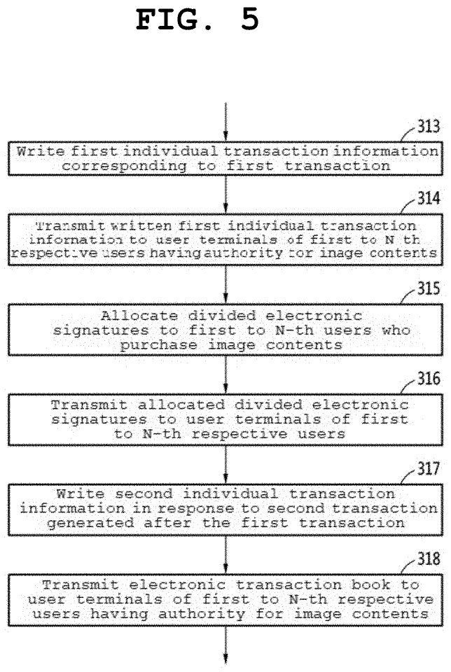

FIG. 5 is a flowchart illustrating an exemplary embodiment in which a user terminal having an authority for image contents allocates and manages a divided electronic signature.

As illustrated in FIG. 5, in the verification transaction method for digital works, first individual transaction information corresponding to the first transaction may be written (step 313).

The written first individual transaction information may be transmitted to the user terminals of the first to N-th respective users having the authority for the image contents (step 314).

The electronic signature received from the copyright holder of the digital work may be divided into a number corresponding to a limited released quantity and the divided electronic signatures may be allocated to the first to N-th users who purchase the image contents (step 315).

Further, in the verification transaction method for digital works, the allocated divided electronic signatures may be transmitted to the user terminals of the first to N-th respective users (step 316).

In the verification transaction method for digital works, the second individual transaction information may be written in response to the second transaction generated after the first transaction, but the electronic transaction book may be written in which both the first individual transaction information and the second individual transaction information are written (step 317).

Thereafter, the electronic transaction book may be transmitted only to the user terminals of the first to N-th respective users having the authority for the image contents (step 318).

Through this, the electronic transaction book may be shared by limited users.

Consequently, when the present invention is used, there is an effect that use and distribution of contents can be activated in addition to copyright protection of image contents which are digital works.

Further, values of the digital works are protected and safe distribution is enabled through individual transactions of the limited-quantity released digital works, and it is possible to verify distributed limited-quantity digital works simultaneously with providing an open market platform so as to enable the individual transactions of the limited-quantity released digital works.

Furthermore, it is possible to derive activation of the image contents by providing a verification and transaction method for an authority which may be transferred through an individual transaction of limited-quantity specific image contents apart from a use authority of an image content providing system constituted by a digital photo frame and a user terminal controlling the digital photo frame, and a service providing server providing an image content service to a digital photo frame based on the control.

The devices described above may be implemented by hardware components, software components, and/or combinations of the hardware components and the software components. For example, the devices and components described in the exemplary embodiments may be implemented by using one or more universal computers or special-purpose computers like any other devices a processor controller, an arithmetic logic unit (ALU), a digital signal processor, a microcomputer, a digital signal processor, a field programmable array (FPA), a programmable logic unit (PUL), a microprocessor, or any other device capable of executing and responding to an instruction. A processing device may perform an operating system (OS) and one or more software applications executed on the operating system. Further, the processing device may access, store, operate, processing, or generate data in response to execution of software. For convenience of understanding, there is a case where it is described that one processing device is used, but those skilled in the art may know that the processing device may include a plurality of processing elements and/or a plurality of types of processing elements. For example, the processing device may include a plurality of processors or one or more processors or one controller. Further, another processing configuration such as a parallel processor is also available.

The software may include a computer program, code, instructions, or a combination of one or more thereof, and configure the processing unit to operate as desired, or instruct a processing device independently or collectively. Software and/or data may be interpreted by the processing device or may be permanently or temporarily embodied in any type of machine, component, physical device, virtual equipment, computer storage medium or device, or a transmitted signal wave in order to provide instructions or data to the processing device. The software may be distributed on a computer system connected through the network and stored or executed by a distributed method. The software and the data may be stored in one or more computer readable recording media.

The method according to the exemplary embodiment may be implemented in a form of a program command which may be performed through various computer means and recorded in the computer readable medium. The computer readable medium may include a program command, a data file, a data structure, etc., singly or combinationally. The program command recorded in the medium may be specially designed and configured for the exemplary embodiment, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler. The hardware device may be configured to be operated with one or more software modules in order to perform the operation of the exemplary embodiment and vice versa.

As described above, although the exemplary embodiments have been described by the limited drawings, those skilled in the art can perform various technical modifications and variations from the description. For example, the described techniques are performed in a different order from the described method, and/or components such as a system, structure, device, circuit, etc., described are collected or combined in a form different from the described method, or even if the components are replaced or substituted by other components or an equivalent, an appropriate result can be achieved.

Therefore, other implementations, other embodiments and claims and equivalents fall within the scope of the following claims.

What is claimed is:

1. A verification and transaction system for digital works among first and N-th users purchasing limited-quantity released digital works, comprising:
a service providing server storing, managing, processing, editing, encoding, and transmitting image contents corresponding to the digital works, and performing registration of a first user having a use authority of the image contents;
a display device being transmitted with the encoded image contents and displaying the transmitted image contents;
an electronic commerce unit performing charging and payment for the purchase of the image contents of the registered first user; and
a first user terminal controlled by a manipulation by the first user to transmit the purchased image contents from the service providing server to the display device,
wherein the electronic commerce unit further provides an open market platform for a first individual transaction of the purchased image contents between the first user and a registered second user.

2. The verification and transaction system of claim 1, wherein the electronic commerce unit includes:
a user payment unit performing account registration and payment for the first transaction of the image contents to the second user;
an authority change registration unit registering a use authority change for the image contents transferred to the second user as a result of the first transaction, and transmitting the registered use authority change information to the service providing server; and
a transaction book writing unit writing first individual transaction information corresponding to the first transaction and transmitting the written first individual transaction information to user terminals of the first to N-th respective users having the authority for the image contents.

3. The verification and transaction system of claim 2, wherein the service providing server includes:
a user authority registration unit dividing an electronic signature received from the copyright holder of the digital work into a number corresponding to a limited released quantity and allocating the divided electronic signatures to the first to N-th users purchasing the image contents, and transmitting the allocated divided electronic signatures to the user terminals of the first to N-th respective users; and
a use authorization unit authorizing the use of the image contents by verifying the allocated divided electronic signatures in response to a service use request.

4. The verification and transaction system of claim 2, wherein the transaction book writing unit writes second individual transaction information in response to a second transaction generated after the first transaction, but writes an electronic transaction book in which both the first individual transaction information and the second individual transaction information are written, and transmits the electronic transaction book to the user terminals of the first to N-th respective users having the authority for the image contents.

5. The verification and transaction system of claim 4, wherein the service providing server includes:
a user authority registration unit dividing an electronic signature received from the copyright holder of the digital work into a number corresponding to a limited released quantity and allocating the divided electronic signatures to the first to N-th users purchasing the image contents, and transmitting the allocated divided electronic signatures to the user terminals of the first to N-th respective users; and
a use authorization unit authorizing the use of the image contents by verifying the allocated divided electronic signatures in response to a service use request,
wherein the use authorization unit authorizes the use of the image contents by verifying the allocated divided electronic signatures and the transmitted electronic transaction book.

6. A verification and transaction method for digital works among first and N-th users purchasing limited-quantity released digital works, comprising:
storing and holding image contents corresponding to the digital works;
receiving a registration request for a use authority of the image contents from a first user terminal;
performing charging and payment for purchasing the image contents according to the received registration request;
receiving a transmission request for the image contents from the first user terminal after the charging and the payment are completed;
performing an authentication procedure for a first display terminal based on terminal information for the first display terminal included in the transmission request when receiving the transmission request; and
transmitting the image contents to the first display terminal when an authentication for the first display terminal is completed.

7. The verification and transaction method of claim 6, further comprising:
encoding the image contents by considering a terminal specification of the first display device terminal.

8. The verification and transaction method of claim 6, further comprising:
collecting a transaction request for the image contents from the first user terminal to a previously registered second user terminal;
checking a use authority for the image contents of which the transaction request occurs; and
approving an electronic commerce of the first user terminal as a checking result of the use authority.

9. The verification and transaction method of claim 8, further comprising:
when the electronic commerce of the first user terminal is approved,
performing account registration and payment for a first transaction to the second user terminal through an open market platform;
registering a use authority change for the image contents transferred to the second user terminal as a result of the first transaction; and
transmitting the registered use authority change information to a service providing server.

10. The verification and transaction method of claim 9, further comprising:
writing first individual transaction information corresponding to the first transaction; and
transmitting the written first individual transaction information to user terminals of first to N-th respective users having an authority for the image contents.

11. The verification and transaction method of claim 9, further comprising:
dividing an electronic signature received from a copyright holder of the digital work into a number corresponding to a limited released quantity and allocating the divided electronic signatures to the first to N-th users who purchase the image contents; and
transmitting the allocated divided electronic signatures to the user terminals of the first to N-th respective users.

12. The verification and transaction method of claim 9, further comprising:
writing second individual transaction information in response to a second transaction generated after the first transaction, but writing an electronic transaction book in which both the first individual transaction information and the second individual transaction information are written; and
transmitting the electronic transaction book to the user terminals of the first to N-th respective users having the authority for the image contents.

13. The verification and transaction method of claim 12, further comprising:
dividing the electronic signature received from the copyright holder of the digital work into a number corresponding to a limited released quantity and allocating the divided electronic signatures to the first to N-th users purchasing the image contents, and transmitting the allocated divided electronic signatures to the user terminals of the first to N-th respective users; and
authorizing the use of the image contents by verifying the allocated divided electronic signatures in response to a service use request,
wherein the authorizing of the use includes:
authorizing the use of the image contents by verifying the allocated divided electronic signatures and the transmitted electronic transaction book.
